(19) United States
(12) Patent Application Publication
(10) Pub. No.: US 2015/0356780 A1
(43) Pub. Date: Dec. 10, 2015

(54) METHOD FOR PROVIDING REAL TIME GUIDANCE TO A USER AND A SYSTEM THEREOF

(71) Applicant: Wipro Limited, Bangalore (IN)

(72) Inventors: Rohit Madegowda, Bangalore (IN); Puja Srivastava, Lucknow (IN); Ramprasad Kanakatte Ramanna, Bangalore (IN); Manoj Madhusudhanan, Bangalore (IN)

(21) Appl. No.: 14/448,555

(22) Filed: Jul. 31, 2014

(30) Foreign Application Priority Data
Jun. 5, 2014 (IN) 2762/CHE/2014

(51) Int. Cl. G06T 19/00

(52) U.S. Cl. CPC G06T 19/006; G06T 2215/16

(57) ABSTRACT

The present subject matter relates to a method and a guidance system for providing real time guidance to a novice user by an expert. The method comprises capturing images of a plurality of actions performed by the user and the expert based on which position and motion data associated with the actions are identified. Further, the method maps the complex environment of the novice user and position & motion data into corresponding digital representations to allow real time interaction between the novice user and the expert. During interaction, the guidance system monitors the performance of the novice user and dynamically suggests a list of alternate actions when the guidance system identifies a deviation in the actions performed by the novice user compared to the actions performed by the expert. If no deviations are identified, the guidance system implements the plurality of actions of the task in the real physical world.

This application claims the benefit of Indian Patent Application No. 2762/CHE/2014 filed Jun. 5, 2014, which is hereby incorporated by reference in its entirety.

### FIELD

The present subject matter is related, in general to enabling interactions between a novice user and an expert via a continuous guidance system, and more particularly, but not exclusively to a method and system for real time remote guidance of a user by an expert in a virtual environment.

### BACKGROUND

A virtual world is a simulated environment in which users may inhabit and interact with one another via avatars. An avatar generally provides a graphical representation of an individual within the virtual world environment. Avatar is usually presented to other users as three-dimensional graphical representations of humanoids. Frequently, virtual world allows multiple users to interact with one another in an environment similar to the real world. Typically, an expert will provide guidance and support remotely to a novice user to accomplish a task. The expert will interact with the novice user in the virtual world and provide instructions in order to train the novice user to perform the tasks under the expert's control.

Few conventional systems train the novice user based on the behavior of the user in the virtual world. Few other systems train the novice user to perform action in real world based on the learnings of performance of actions made by a previous user. However, the real time guidance provided by the expert is not continued till the novice user performs the tasks to the expert's level. Further, there is no real time monitoring of the tasks when performed by the novice user and no corrective actions are suggested in order to enable the novice user to learn the tasks and replicate it exactly to the expert's level.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of providing real time remote guidance by an expert to a novice user performing a task. The method comprising identifying, by a processor of a guidance system, a plurality of actions performed by the expert and the novice user based on information received from one or more sensors associated with the guidance system. Based on the identified plurality of actions, at least one of location, trajectory, and duration data associated with the plurality of actions of the expert and the novice user is tracked. The method further comprises the step of mapping, by the processor, the at least one of location, trajectory and duration data of the expert and the novice user to corresponding digital representation and monitoring, by the processor, the actions performed by the expert and the novice user based on the at least one of digitally represented location, trajectory and duration data. Upon monitoring the actions, the method dynamically determines, by the processor, a list of alternate actions to be performed by the novice user based on the monitored performance for real time guidance to novice user by the expert.

Further, the present disclosure relates to a guidance system for providing real time remote guidance by an expert to a novice user performing a task. The system comprises a processor and one or more sensors communicatively coupled to the processor. The system further comprises a memory communicatively coupled to the processor, wherein the memory stores processor-executable instructions, which, on execution, causes the processor to identify a plurality of actions performed by the expert and the novice user based on information received from one or more sensors associated with the guidance system. The processor is further configured to track at least one of location, trajectory, and duration data associated with the plurality of actions of the expert and the novice user. Upon tracking the data, the processor maps the at least one of location, trajectory and duration data of the expert and the novice user to corresponding digital representation and monitors the actions performed by the expert and the novice user based on the at least one of digitally represented location, trajectory and duration data. The processor further dynamically determines a list of alternate actions to be performed by the novice user based on the monitored performance for real time guidance to novice user by the expert.

Furthermore, the present disclosure relates to a non-transitory computer readable medium including instructions stored thereon that when processed by at least one processor cause a system to identifying a plurality of actions performed by the expert and the novice user based on information received from one or more sensors associated with the guidance system. The processor further performs tracking of at least one of location, trajectory, and duration data associated with the plurality of actions of the expert and the novice user and mapping the at least one of location, trajectory and duration data of the expert and the novice user to corresponding digital representation. The processor further performs monitoring of the actions performed by the expert and the novice user based on the at least one of digitally represented location, trajectory and duration data. Upon monitoring the actions, the processor dynamically determines a list of alternate actions to be performed by the novice user based on the monitored performance for real time guidance to novice user by the expert.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for real time remote guidance by an expert to a novice user in accordance with some embodiments of the present disclosure;

FIG. 2 illustrates a block diagram of a guidance system for providing real time remote guidance by an expert to the novice user in accordance with some embodiments of the present disclosure;

FIG. 3 illustrates a block diagram of a Guidance and Monitoring component (GMC) in accordance with some embodiments of the present disclosure;

FIG. 4 illustrates a schematic representation of virtual screen displayed at the novice user and the expert's end in accordance with some embodiments of the present disclosure;

FIG. 5 illustrates a flowchart of method of real time remote guidance by an expert to a novice in accordance with some embodiments of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for providing real time guidance to a user by an expert in accomplishing a task to the expert's level. In one implementation, the exact continuous motor actions performed by the novice user and the expert located in different locations are reproduced and monitored to provide guidance and feedback to achieve the task to the expected level. The novice user and the expert interact with each other in a virtual environment and the novice would accomplish a task of a real world under the guidance by the expert. The real time guidance is provided by the guidance system that is configured to reproduce the actions of the novice user and the expert in digital representations. The guidance system maps the digital representations of actions performed by the novice user and the expert and determines if any deviation is present. The guidance system also suggests one or more alternate actions to the user in case if any deviations are determined and monitors the alternate actions performed by the user. If the guidance system determines no deviations, then the actions are implemented from the digital world to the real world.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

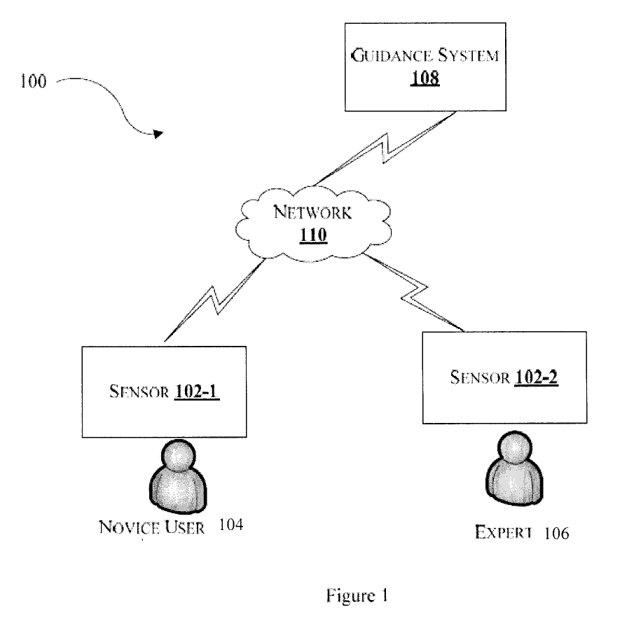

FIG. 1 illustrates a block diagram of an exemplary computer system for real time remote guidance by an expert to a novice in accordance with some embodiments of the present disclosure.

As shown in FIG. 1, a system 100 for providing real time remote guidance by an expert to a novice user comprises one or more components coupled with each other. In one implementation, the system 100 comprises one or more sensors 102-1 and 102-2 (hereinafter, collectively referred to as sensor 102) used by the novice user 104 and the expert 106 respectively. The sensor 102 is configured to capture the movement data as a series of body position points tracked over time. The term “movement” can refer to static or dynamic movement or body position. Examples of the sensor 102 include, one or more sensors attached to the body of novice user and the expert at one or more locations. The sensors may include, but are not limited to, pressure sensors, position, altitude, motion, velocity or optical sensors, energy sensors, atmospheric sensors, health condition sensors. The sensor 102 may also include, for example, GPS altimeter, cameras (visible light, infrared (IR), ultra violet (UV)), range finders, etc. In another implementation, any other hardware or software that captures the movement data can be employed.

The sensor 102 is configured to capture the body movements of the novice user 104 and the expert 106 as input information and transmit the input information to a guidance system 108 for further processing. The input information may be one of a color image, depth image, or an Infrared (IR) image associated with the plurality of actions i.e., body movements of the novice user 104 and the expert 106. The sensor 102 is communicatively coupled to the guidance system 108 through a network 110 for facilitating the transmission of the input information to the guidance system 108 across the network 110.

The network 110 may be a wireless network, wired network or a combination thereof. The network 110 can be implemented as one of the different types of networks, such as intranet, local area network (LAN), wide area network (WAN), the internet, and such. The network 110 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 110 may include a variety of network devices, including routers, bridges, servers, computing devices, storage devices, etc.

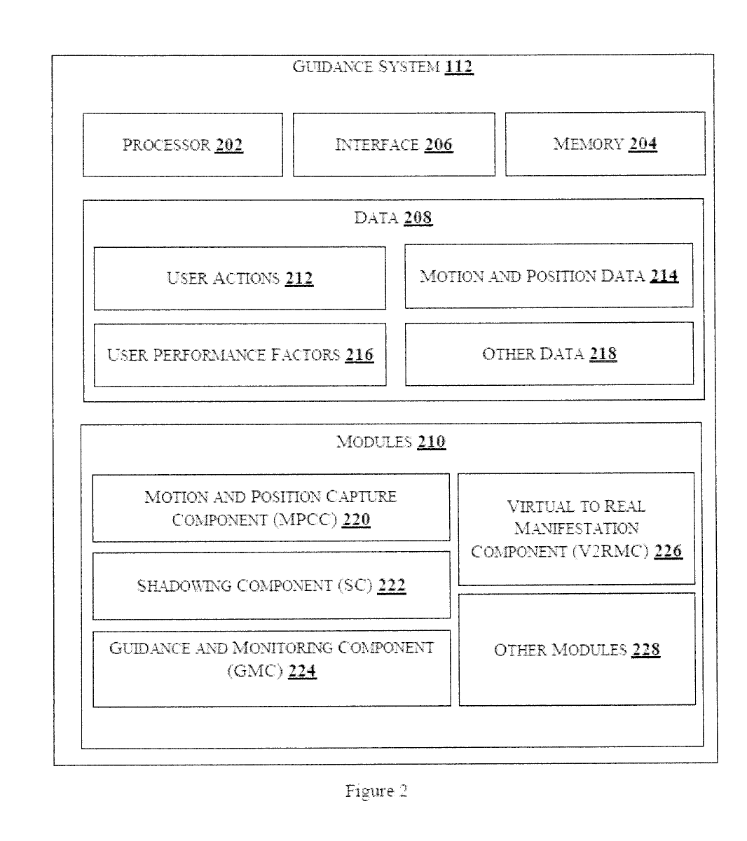

The guidance system 108 is configured to receive the input information from the sensor 102 via the network 110 and provide real time guidance to the novice user 104 based on the received input information. In one implementation, the guidance system (alternately referred to as Expert Guidance Motor Action Reproduction System EGMARS 108), as shown in FIG. 2, includes a central processing unit (“CPU” or “processor”) 202, a memory 204 and an Interface 206. Processor 202 may comprise at least one data processor for executing program components and for executing user- or system-generated requests. A user may include a person, a person using a device such as those included in this disclosure, or such a device itself. The processor 202 may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc. Among other capabilities, the processor 202 is configured to fetch and execute computer-readable instructions stored in the memory 204. The memory 204 can include any non-transitory computer-readable medium known in the art including, for example, volatile memory (e.g., RAM), and/or non-volatile memory (e.g., EPROM, flash memory, etc.).

The interface(s) 206 may include a variety of software and hardware interfaces, for example, a web interface, a graphical user interface, etc. The interface 206 is coupled with the processor 202 and an I/O device. The I/O device is configured to receive inputs from user 104 via the interface 206 and transmit outputs for displaying in the I/O device via the interface 206.

The guidance system 108 further comprises data 208 and modules 210. In one implementation, the data 208 and the modules 210 may be stored within the memory 204. In one example, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

In one implementation, the data 208 may include, for example, a plurality of user actions 212, motion and position data 214, user performance factors 216 and other data 218. In one embodiment, the data 208 may be stored in the memory 204 in the form of various data structures. Additionally, the aforementioned data can be organized using data models, such as relational or hierarchical data models. The other data 218 may be used to store data, including temporary data and temporary files, generated by the modules 210 for performing the various functions of the guidance system 108.

The modules 210 may include, for example, a Motion and Position Capture Component (MPCC) 220, a Shadowing Component (SC) 222, a Guidance and Monitoring Component (GMC) 224, and a Virtual to Real Manifestation Component (V2RMC) 226 coupled with the processor 202. The modules 210 may also comprise other modules 228 to perform various miscellaneous functionalities of the guidance system 108. It will be appreciated that such aforementioned modules may be represented as a single module or a combination of different modules.

In operation, the MPCC 220 receives the input information from the sensor 102 for identifying the plurality of actions performed by the novice user 104 and the expert 106. The input information may be one of a color image, depth image, or an Infrared (IR) image associated with the plurality of actions and each of the plurality of actions includes one or more time characteristics including at least one of a time occurrence and duration of the action. The MPCC 220 further processes the received input information to determine at least one of location, trajectory and duration data associated with the plurality of actions. In one implementation, the MPCC 220 determines skeletal and depth data from the received input information and converts the determined skeletal and depth data into the motion and position data. The motion and position data may include, for example, at least one of the location, trajectory and duration data associated with a plurality of actions performed by the novice user 104 and the expert 106.

Based on the at least one of the determined location, trajectory and duration data, one or more digital representation of the novice user 104 and the expert 106 is generated. In one implementation, the SC 222 receives the at least one of the determined location, trajectory and duration data from MPCC 220 and converts the received location, trajectory and duration data into corresponding digital representations.

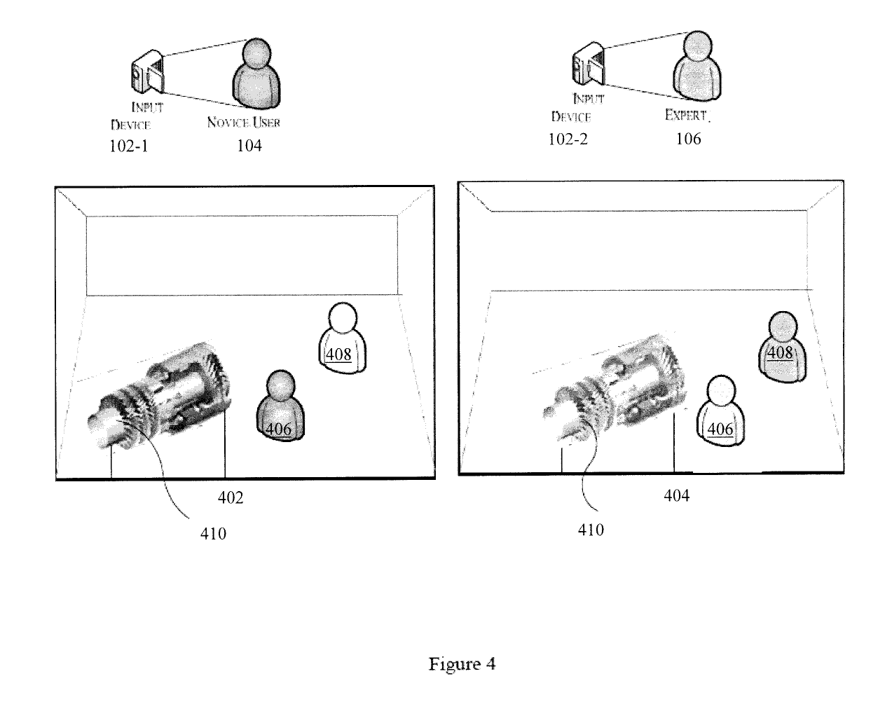

The digital representation may be for example, an avatar as shown in FIG. 4 which may be any two or three dimensional representation of a human figure recorded at rest and/or during motion reconstructed from the input information or input images captured by the sensor 102. The virtual screens 402 and 404 displayed at the novice user 104 and the expert's 106 end respectively displays the avatars of the novice user 104 and the expert 106. The SC 222 generates avatars 406, 408 of the novice user 104 and the expert 106 in virtual environment based on the novice user and the expert images captured by the sensor 102. In one example, the avatar 406 of the novice user 104 may be represented in the virtual environment before the expert 106 and similarly, the avatar 408 of the expert 106 will be represented in the virtual environment before the novice user 104. The avatars 406, 408 of the novice user 104 and the expert 106 can be differentiated by different colors, different shapes or other differentiating features so that any deviation in motion between the avatars of the novice user 104 and the expert 106 can be readily appreciated. The avatars of the novice user 104 and the expert 106 are synchronized in space and/or time so that the avatars can move in real time corresponding to the movements/actions of the novice user 104 and the expert 106 in real world. The SC 222 converts the real time movements/actions of the novice user 102 and the expert 106 into movement/actions of the novice user and the expert avatars by digitally representing at least one of the location, trajectory and the duration data associated with each and every movement/action of the novice user 104 and the expert 106 in virtual environment.

Further, the SC 222 receives the representations of the novice user's 104 proximate physical environment 410 and converts into corresponding digital representations in virtual environment. In one implementation, the input information provided by the sensor 102 may include at least video of a three-dimensional representation of the novice user's 104 physical environment 410. The video may include for example, representations of physical and non-physical objects in the user's proximate physical environment. The SC 222 maps the received physical representations of the novice user's environment 410 into corresponding digital representations in virtual environment so that the avatars of the novice user 104 and the expert 106 may interact with the virtual objects of the virtual environment. Interaction of the avatars 406, 408 in the virtual environment is timely synchronized with the interaction of the novice user 104 and the expert 106 in the physical environment. The interaction may include the movements/actions performed by the novice user 104 and the expert 106 The digital representations of the novice user's 104 physical environment 410 and the motion and position data are then processed by the GMC 224 to monitor the performance of the novice user 104 and the expert 106.

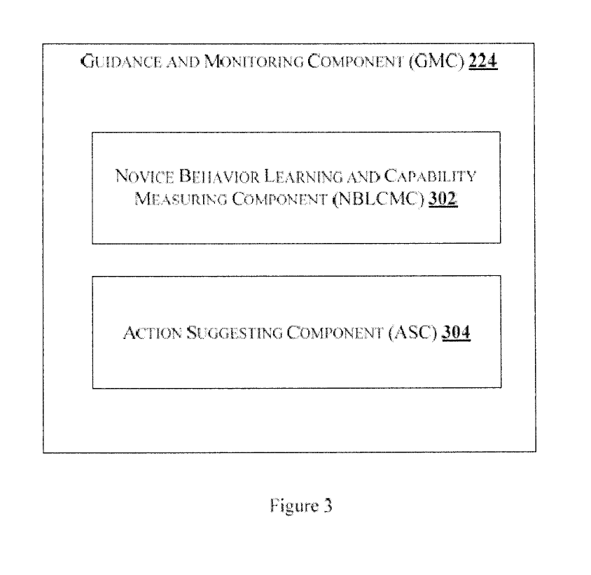

The GMC 224 monitors the movements/actions performed by the avatars of the novice user 104 and the expert 106 and dynamically provides guidance and feedback based on the monitored performance. As illustrated in FIG. 3, the GMC 224 comprises at least a Novice Behavior Learning and Capability Measuring Component (NBLCMC) 302 and an Action Suggesting Component (ASC) 304 coupled with each other. In one implementation, the NBLCMC 302 monitors the plurality of actions performed by the novice user 104 and measures the performance of the novice user 104 and the expert 106 based on the digitally represented location, trajectory and duration data associated with the plurality of actions. The NBLCMC 302 further determines as to whether the location, trajectory and duration data associated with the plurality of actions of the novice/first user 104 exactly matches with the location, trajectory and duration data associated with the plurality of actions of the expert/second user 106. If the NBLCMC 302 determines that there is no match between the location, trajectory and duration data of the novice user 104 and the expert 106, then the ASC 304 dynamically suggests a list of alternate actions to be performed by the novice user 104 in order to achieve the exact match between the actions performed by the novice user 104 and the expert 106. In one implementation, the ASC 304 dynamically determines the list of alternate actions or adjustments that the novice user 104 must perform in order to replicate the actions performed by the expert 106. Examples of adjustments can include a change in the speed with which the action is performed, change in the range of motion, and change in the angle of position of the plurality of actions.

The ASC 304 dynamically determines the list of alternate actions/adjustments based on deviations in the location, trajectory and duration data and further transmits the determined list of alternate actions to the expert 106. The expert 106 receives the list of alternate actions, analyzes the received alternate actions and transmits a confirmation signal to the ASC 304 via the interface 206 if the analyzed list of alternate actions satisfactorily enables the novice user 104 to accomplish the task with precision and minimum deviation not exceeding a predetermined threshold.

Upon receiving the confirmation signal, the ASC 304 transmits the list of alternate actions to be performed to the novice user 104. The NBLCMC 302 continuously monitors the alternate actions performed by the avatar of the novice user 104 and determines the deviation if any. In one implementation, the avatars of the novice user 104 and the expert 106 are overlaid so that any deviation in the motion or action being performed by the novice user 104 can be detected in terms of unmatched location, trajectory and duration data.

Upon determining that there is no deviation, the NBLCMC 302 generates a matching signal and transmits to the expert 106 based on which the expert 106 will generate a trigger signal indicative of the expert satisfaction on the actions performed by the novice user and the accomplishment of the task in real world. Upon receiving the trigger signal, the guidance system 108, implements the task in real world.

In one implementation, the Virtual to Real Manifestation Component (V2RMC) 226 receives the trigger signal from the expert 106 and triggers the system 100 to accomplish task in real world.

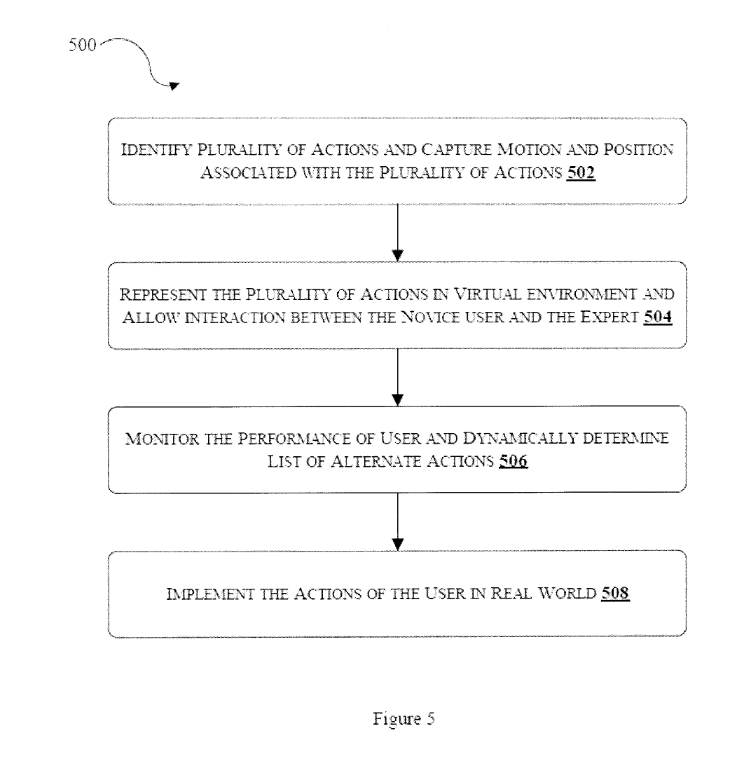

FIG. 5 illustrates a flowchart of method of dynamic risk testing in accordance with an embodiment of the present disclosure.

As illustrated in FIG. 5, the method 500 comprises one or more blocks implemented by the guidance system 108 for providing real time remote guidance by an expert to a novice user 104 to accomplish a task. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method 500. Additionally, individual blocks may be deleted from the method 500 without departing from the spirit and scope of the subject matter described herein. Furthermore, the method 500 can be implemented in any suitable hardware, software, firmware, or combination thereof.

At block 502, identify plurality of actions and capture the motion and position data associated with the plurality of actions. In one embodiment, the sensor 102 is configured to capture the body movements of the novice user 104 and the expert 106 as input information and transmit the input information to a server 108 for further processing. The input information may be one of a color image, depth image, or an Infrared (IR) image associated with the plurality of actions i.e., body movements of the novice user 104 and the expert 106. Based on the motion and position data, the plurality of actions is identified.

At block 504, represent the actions in virtual environment and allow interaction between the novice user and the expert. In one embodiment, the MPCC 220 receives the input information from the sensor 102 for identifying the plurality of actions performed by the novice user 104 and the expert 106. The MPCC 220 further processes the received input information to determine at least one of location, trajectory and duration data associated with the plurality of actions. In one implementation, the MPCC 220 determines skeletal and depth data from the received input information and converts the determined skeletal and depth data into the motion and position data. The motion and position data may include, for example, at least one of the location, trajectory and duration data associated with a plurality of actions performed by the novice user 104 and the expert 106. Based on the at least one of the determined location, trajectory and duration data, one or more digital representation of the novice user 104 and the expert 106 is generated. In one implementation, the SC 222 receives the at least one of the determined location, trajectory and duration data from MPCC 220 and converts the

The SC 222 generates avatars 406, 408 of the novice user 104 and the expert 106 in virtual environment based on the novice user and the expert images captured by the sensor 102. In one example, the avatar 406 of the novice user 104 will be represented in the virtual environment before the expert 106 and similarly, the avatar 408 of the expert 106 will be represented in the virtual environment before the novice user 104. The SC 222 converts the real time movements/actions of the novice user 102 and the expert 106 into movement/actions of the novice user and the expert avatars 406, 408 by digitally representing at least one of the location, trajectory and the duration data associated with each and every movement/action of the novice user 104 and the expert 106 in virtual environment. Further, the SC 222 receives the representations of the novice user's 104 proximate physical environment 410 and converts into corresponding digital representations in virtual environment. In one implementation, the input information provided by the sensor 102 may include at least video of a three-dimensional representation of the novice user's 104 physical environment. The SC 222 maps the received physical representations of the novice user's environment into corresponding digital representations in virtual environment so that the avatars of the novice user 104 and the expert 106 may interact with the virtual objects of the virtual environment. Interaction of the avatars in the virtual environment is timely synchronized with the interaction of the novice user 104 and the expert 106 in the physical environment.

At block 506, monitor the performance of the novice user and dynamically determine list of alternate actions. In one embodiment, the GMC 224 monitors the movements/actions performed by the avatars of the novice user 104 and the expert 106 and dynamically provides guidance and feedback based on the monitored performance. In one implementation, the NBLCMC 302 monitors the plurality of actions performed by the novice user 104 and measures the performance of the novice user 104 and the expert 106 based on the digitally represented location, trajectory and duration data associated with the plurality of actions. The NBLCMC 302 further determines as to whether the location, trajectory and duration data associated with the plurality of actions of the novice/first user 104 exactly matches with the location, trajectory and duration data associated with the plurality of actions of the expert/second user 106. If the NBLCMC 302 determines that there is no match between the location, trajectory and duration data of the novice user 104 and the expert 106, then the ASC 304 dynamically suggests a list of alternate actions to be performed by the novice user 104 in order to achieve the exact match between the actions performed by the novice user 104 and the expert 106. In one implementation, the ASC 304 dynamically determines the list of alternate actions or adjustments that the novice user 104 must perform in order to replicate the actions performed by the expert 106. Examples of adjustments can include a change in the speed with which the action is performed, change in the range of motion, and change in the angle of position of the plurality of actions. The ASC 304 dynamically determines the list of alternate actions/adjustments based on deviations in the location, trajectory and duration data and further transmits the determined list of alternate actions to the expert 106.

At block 508, implement the actions of the user in real time in real world. In one implementation, the expert 106 receives the list of alternate actions, analyzes the received alternate actions and transmits a confirmation signal to the ASC 304 via the interface 206 if the analyzed list of alternate actions satisfactorily enables the novice user 104 to accomplish the task with precision and minimum deviation not exceeding a predetermined threshold.

Upon receiving the confirmation signal, the ASC 304 transmits the list of alternate actions to be performed to the novice user 104. The NBLCMC 302 continuously monitors the alternate actions performed by the avatar 406 of the novice user 104 and determines the deviation if any. In one implementation, the avatars 406, 408 of the novice user 104 and the expert 106 are overlaid so that any deviation in the motion or action being performed by the novice user 104 can be detected in terms of unmatched location, trajectory and duration data.

Upon determining that there is no deviation, the NBLCMC 302 generates a matching signal and transmits to the expert 106 based on which the expert 106 will generate a trigger signal indicative of the expert satisfaction on the actions performed by the novice user and the accomplishment of the task in real world. Upon receiving the trigger signal, the guidance system 108, implements the task in real world.

In one implementation, the Virtual to Real Manifestation Component (V2RMC) 226 receives the trigger signal from the expert 106 and triggers the system 100 to accomplish the plurality of actions of the task in real world.

The specification has described a method and a system for providing real time remote guidance by an expert to a novice user to accomplish a task. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of providing real time remote guidance, the method comprising:
identifying, by a processor of a guidance system, a plurality of actions performed by an expert and a novice user based on information received from one or more sensors;
tracking, by the processor of the guidance system, at least one of location, trajectory, or duration data associated with the plurality of actions of the expert and the novice user;
mapping, by the processor of the guidance system, the at least one of location, trajectory, or duration data of the expert and the novice user to a corresponding digital representation;
monitoring, by the processor of the guidance system, the actions performed by the expert and the novice user based on the at least one of the digitally represented location, trajectory, or duration data; and
determining, by the processor of the guidance system, a list of alternate actions to be performed by the novice user based on the monitored actions and outputting the list of alternate actions to provide real time guidance to the novice user by the expert.

2. The method as claimed in claim 1, further comprising mapping, by the processor of the guidance system, physical and non-physical objects in a proximate physical environment of the novice user into a corresponding digital representation in a virtual environment.

3. The method as claimed in claim 1, further comprising:
determining, by the processor of the guidance system, whether the actions performed by the novice user exactly matches with the actions performed by the expert; and
implementing, by the processor of the guidance system, the actions performed by the novice user in real time based upon the determination.

4. The method as claimed in claim 1, wherein one or more of the actions include a plurality of movements of the novice user and the expert in a virtual environment.

5. The method as claimed in claim 1, wherein one or more of the actions include one or more time characteristics including at least one of a time occurrence or a duration of the action.

6. The method as claimed in claim 1, wherein the outputting further comprises transmitting the list of alternate actions to the expert for guiding the novice user to perform the list of alternate actions.

7. The method as claimed in claim 1, wherein the novice user and the expert are represented as three-dimensional avatars in virtual environment.

8. A guidance system, comprising:
a processor;
one or more sensors coupled to the processor;
a memory coupled to the processor, wherein the memory stores processor-executable instructions, which when executed by the processor cause the processor to perform steps comprising:
identifying a plurality of actions performed by an expert and a novice user based on information received from the one or more sensors;
tracking at least one of location, trajectory, or duration data associated with the plurality of actions of the expert and the novice user;
mapping the at least one of location, trajectory, or duration data of the expert and the novice user to a corresponding digital representation;
monitoring the actions performed by the expert and the novice user based on the at least one of the digitally represented location, trajectory, or duration data; and
determining a list of alternate actions to be performed by the novice user based on the monitored actions and outputting the list of alternate actions to provide real time guidance to the novice user by the expert.

9. The system as claimed in claim 8, wherein processor-executable instructions, when executed by the processor, further cause the processor to perform steps comprising mapping physical and non-physical objects in a proximate physical environment of the novice user into a corresponding digital representation in a virtual environment.

10. The system as claimed in claim 8, wherein processor-executable instructions, when executed by the processor, further cause the processor to perform steps comprising:
determining whether the actions performed by the novice user exactly matches with the actions performed by the expert; and
implementing the actions performed by the novice user in real time based upon the determination.

11. The system as claimed in claim 8, wherein one or more of the actions include a plurality of movements of the novice user and the expert in a virtual environment.

12. The system as claimed in claim 8, wherein one or more of the actions include one or more time characteristics including at least one of a time occurrence or a duration of the action.

13. The system as claimed in claim 8, wherein the outputting further comprises transmitting the list of alternate actions to the expert for guiding the novice user to perform the list of alternate actions.

14. The system as claimed in claim 8, wherein the novice user and the expert are represented as three-dimensional avatars in virtual environment.

15. A non-transitory computer readable medium including instructions stored thereon that when processed by at least one processor cause a system to perform steps comprising:
identifying a plurality of actions performed by an expert and a novice user based on information received from one or more sensors;
tracking at least one of location, trajectory, or duration data associated with the plurality of actions of the expert and the novice user;
mapping the at least one of location, trajectory, or duration data of the expert and the novice user to a corresponding digital representation;
monitoring the actions performed by the expert and the novice user based on the at least one of the digitally represented location, trajectory, or duration data; and
determining a list of alternate actions to be performed by the novice user based on the monitored actions and outputting the list of alternate actions to provide real time guidance to the novice user by the expert.

16. The medium as claimed in claim 15, wherein the instructions, when processed by the at least one processor, further cause the at least one processor to perform steps comprising mapping physical and non-physical objects in a proximate physical environment of the novice user into a corresponding digital representation in a virtual environment.

17. The medium as claimed in claim 15, wherein the instructions, when processed by the at least one processor, further cause the at least one processor to perform steps comprising:
determining whether the actions performed by the novice user exactly matches with the actions performed by the expert; and
implementing the actions performed by the novice user in real time based upon the determination.

18. The medium as claimed in claim 15, wherein one or more of the actions include a plurality of movements of the novice user and the expert in a virtual environment.

19. The medium as claimed in claim 15, wherein one or more of the actions include one or more time characteristics including at least one of a time occurrence or a duration of the action.

20. The medium as claimed in claim 15, wherein the outputting further comprises transmitting the list of alternate actions to the expert for guiding the novice user to perform the list of alternate actions.

21. The medium as claimed in claim 15, wherein the novice user and the expert are represented as three-dimensional avatars in virtual environment.
